(19) United States
(12) Patent Application Publication
(10) Pub. No.: US 2010/0311033 A1
(43) Pub. Date: Dec. 9, 2010

(54) Analytical measures for student-collected articles for educational project having a topic

(76) Inventors: Jhilmil Jain, Mountain View, CA (US); Malena Rosa Mesarina, San Francisco, CA (US); Mohamed E. Dekhil, Santa Clara, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/481,474

(22) Filed: Jun. 9, 2009

(51) Int. Cl. G09B 7/00

(52) U.S. Cl. 434/362

(57) ABSTRACT

A student collects articles for a educational project having a topic. Analytical measures for the articles are determined in relation to the topic of the educational project. The analytical measures can include a relevance of the articles collected by the student to the topic. The analytical measures can include a coverage of how well the articles collected by the student cover the topic. The analytical measures can include a uniqueness of the articles collected by the student in comparison to one another.

### BACKGROUND

In the past, students typically performed research for a school project by going to the library, and locating and photocopying books and magazine and newspaper articles that pertain to the topic of the school project. However, since the advent of the Internet and due to the popularity of search engines, students are now much more likely to perform such research online. A student may collect web pages that pertain to the topic of the school project, for instance, in lieu of going to the library and locating relevant books and magazine and newspaper articles.

### BRIEF DESCRIPTION OF THE DRAWINGS

FIG. 1 is a flowchart of a method for determining various analytical measures of a number of collected articles in relation to a topic, according to an embodiment of the present disclosure.

FIG. 2 is a flowchart of a method for determining given concepts that are related to a topic, according to an embodiment of the present disclosure.

FIG. 3 is a flowchart of a method for determining the relevance of collected articles to a topic, according to an embodiment of the disclosure.

FIG. 4 is a flowchart of a method for determining the coverage of how well collected articles cover a topic, according to an embodiment of the disclosure.

FIG. 5 is a flowchart of a method for determining the uniqueness of the collected articles in comparison to one another, according to an embodiment of the present disclosure.

FIG. 6 is a flowchart of a method for determining various analytical measures of a number of collected articles in relation to a topic having one or more subtopics, according to an embodiment of the present disclosure.

FIG. 7 is a diagram of a system, according to an embodiment of the present disclosure.

### DETAILED DESCRIPTION OF THE DRAWINGS

As noted in the background, today students commonly perform research for school projects online, collecting web pages that pertain to the topics of the school projects, instead of photocopying relevant books and magazine and newspaper articles. However, while computer technology has aided students in how they perform research for school projects, computer technology has not as significantly aided teachers in assessing how well their students have performed such research. Commonly, for instance, a teacher may still have to sift through and review the web pages that a student has collected and which the student believes pertains to the topic of a given school project, to determine how well the student has completed the project.

Embodiments of the present disclosure overcome these shortcomings. In particular, embodiments of the present disclosure permit analytical measures for the articles collected by the student—such as web pages—in relation to the topic of a school project to be determined. Such analytical measures include relevance, coverage, and uniqueness. Relevance indicates how relevant the articles collected by the student are to the topic of the school project. Coverage indicates how well the articles collected by the student completely cover the topic. Uniqueness indicates how unique the articles collected by the student are in comparison to one another.

As such, embodiments of the present disclosure can at least partially relieve a teacher of what can be a painstaking process of manually sifting through and reviewing the articles collected by a student to determine how well the student has completed a school project. Automated analytical measures, such as relevance, coverage, and uniqueness, can provide a teacher baseline values of how well a student has completed a school project. The teacher can thus spend more of his or her time on individualized attention to each student.

For instance, the analytical measures can provide for automatic evaluation as to how well the articles collected by the student satisfy the school project, so that the teacher does not have to manually evaluate the articles. As another example, the progress of the student can be tracked on a week-by-week basis, or on another period basis. As such, the analytical measures can provide the teacher with various metrics as to how well the student is performing in relation to the school projection in question.

A school project is considered as one type of educational project, and can broadly be defined as including activities as varied as due diligence, scientific research, and learn activities, among other types of activities. A student that is assigned or that completes such an educational project thus can be broadly defined as an individual or entity that effects the educational project.

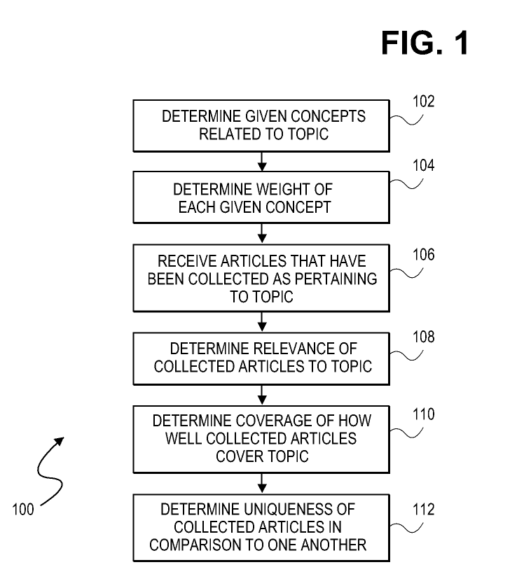

FIG. 1 shows a method 100 for determining these analytical measures, according to an embodiment of the present disclosure. As with methods of other embodiments of the disclosure, at least some parts of the method 100 can be implemented by a computer program executed by a processor of a computing device. The computing device may be a desktop or laptop computer, for instance. The computer program may be stored on a computer-readable medium of the computing device, such as a volatile or a non-volatile semiconductor memory, or a magnetic medium like a hard disk drive, among other types of computer-readable media. Execution of the computer program by the processor of the computing device therefore results in performance of the method 100 in this embodiment.

The method 100 determines a number of given concepts related to a selected topic for a school project (102). The topic for the school project is typically selected by a teacher. A concept is a phrase of one or more words that pertain to the topic. The terminology “given concepts” is used herein to distinguish these concepts that are determined in relation to the topic from other concepts, which as described below are determined in relation to the articles collected by a student. As an example, a teacher may select the topic of a school project as the solar system. As such, the method 100 determines given concepts that are related to this topic. Examples of such concepts that may be determined may include the names of various planets, for instance, such as “Saturn,” “Earth,” “Venus,” and so on.

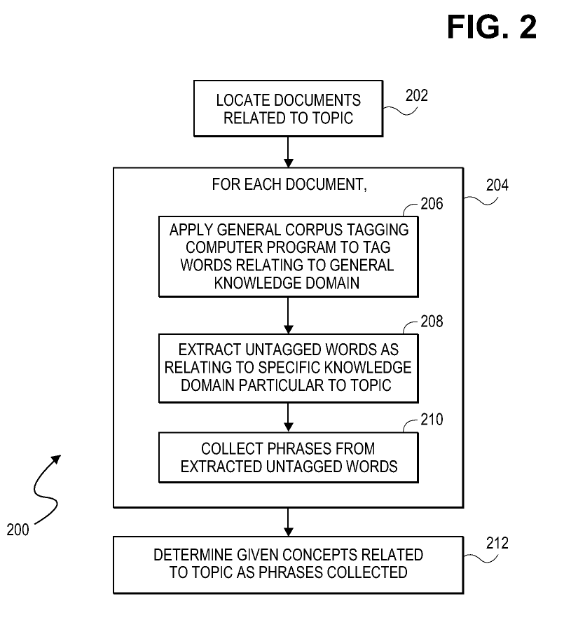

FIG. 2 shows a method 200 for determining given concepts related to a selected topic of a school project in part 102, according to an embodiment of the present disclosure. A number of documents related to the topic are located (202). It is noted that each document has a number of words. In one embodiment, these documents are web pages, and are located by performing a search for relevant web pages using an Internet search engine. One example of an Internet search engine is the Google search engine, which is accessible at the Internet web site www.google.com, and operated by Google, Inc., of Mountain View, Calif.

For each document that is located, the following is performed (204). First a general corpus tagging computer program is applied to the document (206). The result of applying this program to the document is the identification, or tagging, of a first subset of the words of the document that relate to a general knowledge domain. An example of such a general corpus tagging computer program is the Penn Treebank tagging computer program, which is available and described at the Internet web site www.cis.upenn.edu/˜treebank/.

A general knowledge domain is a domain of knowledge that encompasses general knowledge relevant across a large number of different topics or areas. A general knowledge domain is compared to a specific knowledge domain that is particular to a given topic or area. For example, a document related to the solar system may include specific knowledge that is particular to both the specific knowledge domain of this topic, as well as general knowledge that is more general, and which pertains to a number of topics including but not limited to the solar system.

The method 200 then extracts a second subset of the words of the document that were not tagged as being part of the first subset (208). These words are presumed to relate to the specific knowledge domain particular to the topic in question. For example, as to the topic of the solar system, once all general knowledge words have been tagged in a located document, the remaining words within the document are presumed to be specific knowledge words pertaining to the solar system. As such, phrases are collected from the second subset of the words that have been extracted, where each phrase includes one or more contiguous words of the document that appear within the second subset of the words that have been extracted (210). The method 200 determines the given concepts related to the topic of the school project as the phrases that have been collected (212).

Referring back to FIG. 1, a weight of each given concept to the topic of the school project is then determined (104). The weight of a given concept can be defined as a number of times the given concept appears within all the documents that have been located, divided by a total number of times all the given concepts appear within the documents. Mathematically, the weight of a given concept can be expressed as:

$${w}_{i} = \frac{freq ( {concept}_{i} )}{{\sum }_{j = 1}^{n} freq ( {concept}_{j} )} \qquad ( 1 )$$

In equation (1), Wᵢ is the weight of conceptᵢ. The function freq(conceptₓ) is the number of times conceptₓ appears within all the documents that have been located, which number n.

Articles that have been collected by a student as pertaining to the topic of the school project in question are then received (106). The articles may include web pages, which the student has collected by performing searches using an Internet search engine. However, in other embodiments, the articles may include other types of textual documents that were not found using an Internet search engine and/or that are not web pages. The articles may further include multimedia files, which contain images, audio, and/or video, and which are or have been tagged with text representative of the subject matter of such images, audio, and/or video.

The method 100 determines three types of analytical measures of the articles collected by the student. First, the relevance of the articles collected by the student to the topic of the school project is determined (108). Second, the coverage of how well the articles collected by the student cover the topic of the school project is determined (110). Third, the uniqueness of the articles collected by the student in comparison to one another is determined (112). How each of these different types of analytical measures can be determined in various embodiments of the present disclosure is now described.

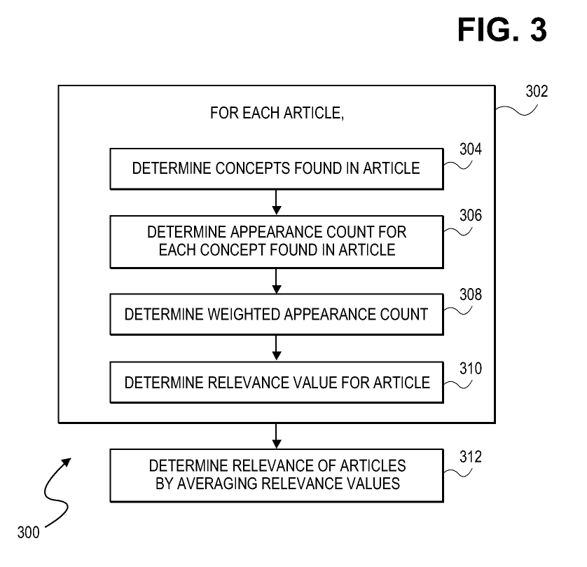

FIG. 3 shows a method 300 for determining the relevance of the articles collected by the student to the topic of the school project in part 108, according to an embodiment of the present disclosure. For each article collected by the student, the following is performed (302). First, the concepts found in the article are determined (304). The concepts of the article are each a phrase of one or more words that are at least substantially particular to a knowledge domain specific to the article. The concepts of an article typically differ to some degree from the given concepts related to the topic, depending on how related or unrelated the article in question is to the topic of the school project.

Determining the concepts of the article can be achieved in a number of different ways. In one approach, parts 204 and 212 of FIG. 2 can be performed in relation to the article in order to locate the concepts found in the article. In another approach, the given concepts that have been found as a result of performing part 102 of FIG. 1 can be each searched against the text of the article, to determine which of the given concepts are located in the article.

An appearance count is then determined for each concept found in the article (306). The appearance count of a concept is equal to the number of times the concept appears in the article. The weighted appearance count is also determined for each concept found in the article (308). The weighted appearance count of a concept is equal to the appearance count determined in part 306, multiplied by the weight of the concept determined in part 104 of FIG. 1. That is, if a concept found in the article matches a given concept, then the weight of the concept is equal to the weight of the matching given concept determined in part 104. However, if a concept found in the article does not match any given concept, then the weight of the concept is equal to zero.

The relevance value for the article is determined (310). The relevance value is equal to an average of the weighted appearance counts for the concepts in the article. Mathematically, the relevance value can be expressed as:

$${R}_{i} = \frac{{\sum }_{j = 1}^{C} freq ( {concept}_{j} ) \times {w}_{j}}{C} \qquad ( 2 )$$

In equation (2), Rᵢ is the relevance value for article i and C is the number of concepts found in the article, whereas freq(conceptⱼ) is the appearance count of conceptⱼ, and wⱼ is the weight of conceptⱼ. As such, freq(conceptⱼ)×wⱼ is the weighted appearance count of conceptⱼ.

Once part 302 has been performed for each article collected by the student for the school project, the relevance of all the articles to the topic is then determined (312). Specifically, the relevance of the articles collected by the student to the topic is determined by averaging the relevance values for the articles. Mathematically, the relevance can be expressed as:

$$R = \frac{{\sum }_{i = 1}^{N} {R}_{i}}{N} \qquad ( 3 )$$

In equation (3), R is the relevance for all the articles collected by the student for the school project and Rᵢ is the relevance value for article i, where there are N total articles.

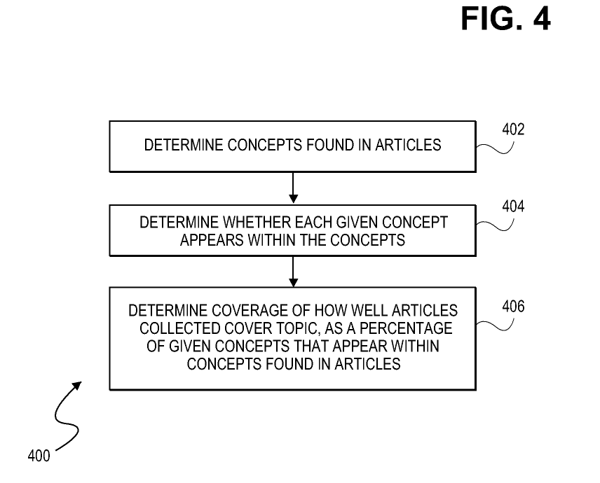

FIG. 4 shows a method 400 for determining the coverage of how well the articles collected by the student cover the topic of the school project in part 110 of FIG. 1, according to an embodiment of the present disclosure. The concepts found in all the articles collected by the student are determined (402). As noted above, the concepts of the articles are each a phrase of one or more words that are at least substantially particular to knowledge domains specific to the articles. The concepts of the articles typically differ to some degree from the given concepts related to the topic, depending on how related or unrelated the articles are to the topic of the school project. Determining the concepts of the articles collected by the student can be performed in one embodiment as has been described in relation to part 304 of FIG. 3.

The method 400 determines whether each given concept determined in part 102 of FIG. 1 as being related to the topic of the school project appears within the concepts of the articles as determined in part 402 (404). The coverage of how well the articles collected by the student cover the topic of the school project is then determined (406). The coverage is specifically determined as the percentage of the given concepts that appear within the articles, which is the percentage of the given concepts that appear within the concepts of the articles.

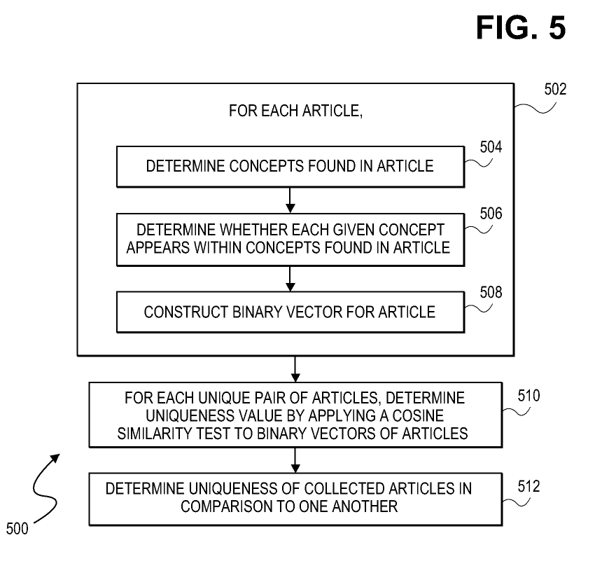

FIG. 5 shows a method 500 for determining the uniqueness of the articles collected by the student for the school project in comparison to one another in part 112 of FIG. 1, according to an embodiment of the present disclosure. For each article collected by the student, the following is performed (502). The concepts found in the article are determined (504), as has been described in relation to part 304 of FIG. 3. It is then determined whether each given concept related to the topic as determined in part 102 of FIG. 1 is found in the article in question (506). For instance, the concepts of the article may be searched for a given concept to determine whether the given concept is found in the article.

A binary vector for the article is constructed (508). The binary vector includes a series of binary values corresponding to the given concepts determined in part 102 of FIG. 1. Each binary value is equal to zero or one. A binary value is equal to zero if its corresponding given concept is not found in the concepts of the article, and is equal to one if its corresponding given concept is found in the concepts of the article. The binary vector for an article may be mathematically expressed as:

bvecᵢ=<bvalᵢ₁, bvalᵢ₂, . . . , bvalᵢₘ> (4)

In equation (4), bvecᵢ is the binary vector for article i. This binary vector has binary values bvalᵢ₁, bvalᵢ₂, . . . , bvalᵢₘ corresponding to the m given concepts, where a binary value bvalᵢₓ is equal to zero if the given concept x is not found in article i and is equal to one if the given concept x is found in article i.

Once part 502 has been performed for each article located by the student, for each unique pair of articles, a uniqueness value is determined (510). For example, if there are three articles a, b, and c, then there are three unique pairs of articles ab, ac, and bc. The uniqueness value is determined for a unique pair of articles by applying a cosine similarity test to the binary vectors of these articles. The uniqueness value for a unique pair of articles can be mathematically expressed as:

$${U}_{ab} = cos ( {bvec}_{a} , {bvec}_{b} ) = \frac{{bvec}_{a} \cdot {bvec}_{b}}{\vert {bvec}_{a} \vert \vert {bvec}_{b} \vert} \qquad ( 5 )$$

In equation (5), U_{ab} is the uniqueness value for the unique pair of article a and article b having binary vectors bvecₐ and bvec_{b}, respectively. The cosine similarity test for two binary vectors x and y is expressed as cos(x, y), and is equal to the dot product of the two vectors, divided by the product of the absolute values of the two vectors. The cosine similar test of equation (5) results in a value between −1 and 1, where −1 indicates that the two articles do not share any concepts and 1 indicates that they share all their concepts.

The uniqueness of the articles collected by the student for the school project is determined by averaging the uniqueness values for the unique pairs of articles (512). Mathematically, the uniqueness can be expressed as:

$$U = \frac{{\sum }_{i = 1}^{P} {U}_{i}}{P} \qquad ( 6 )$$

In equation (6), U is the uniqueness of the articles collected by the student for the school project and Uᵢ is the uniqueness value for the unique pair of articles i, where there are P total unique pairs of articles.

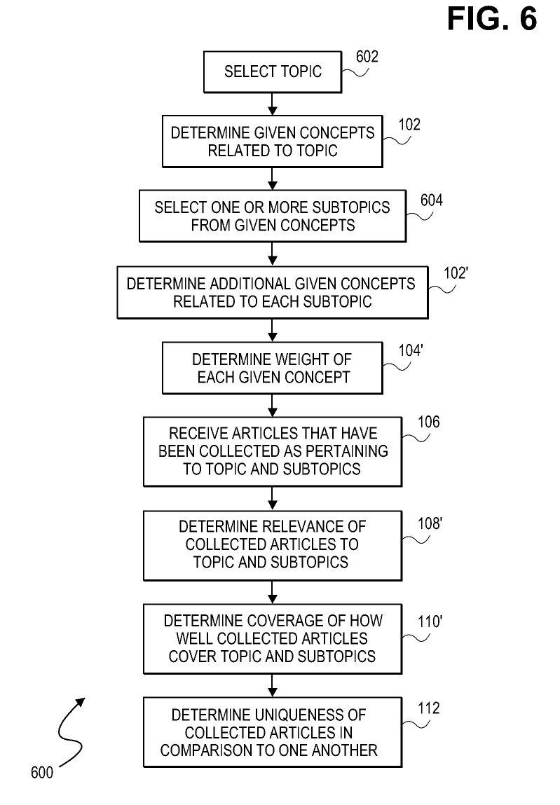

The methods that have been described can be extended to scenarios in which, besides a topic being selected by a teacher, a number of subtopics of the topic are also selected by the teacher. FIG. 6 shows such a method 600, according to an embodiment of the present disclosure. A teacher is permitted to select a topic for a school project (602), and given concepts related to the topic are determined (102), as has been described above in relation to FIG. 1.

Furthermore, the teacher is permitted to select one or more subtopics, from the given concepts related to the topic that have been determined in part 102 (604). For example, if the topic is the solar system, the teacher may select the given concepts “Saturn,” “Earth,” and “Venus” as the desired subtopics. Thereafter, additional given concepts related to each subtopic are determined (102′). Part 102′ is performed in the same way that part 102 is performed, as has been described above in relation to FIG. 2, but is performed in relation to a subtopic as opposed to in relation to the topic as in part 102.

The weight of each given concept is determined (104′). Part 104′ is performed in the same way that part 104 is performed, as has been described above in relation to FIG. 1, but is performed in relation to both the given concepts related to the topic and the given concepts related to the subtopics, as opposed to just in relation to the topic as in part 104. Articles that have been collected by a student for the school project are received (106), as has been described above in relation to FIG. 1.

Three types of analytical measures are determined as to the collected articles in relation to the topics and the subtopics, as before. First, the relevance of the collected articles to the topic and the subtopics is determined (108′). Part 108′ is performed in the same way that part 108 is performed, such as by performing the method 300 of FIG. 3. However, in part 108′, the method 300 is performed in relation to the given concepts of each subtopic to determine the relevance of the collected articles as to each subtopic. The relevance of the collected articles to the topic itself may then be determined by averaging the relevances to the subtopics. For example, if there are three subtopics, then the method 300 is performed in relation to each subtopic, resulting in three relevances. These three relevances can then be averaged to result in the relevance of the collected articles to the topic itself.

Second, the coverage of how well the collected articles cover the topic and the subtopics is determined (110′). Part 110′ is performed in the same way that part 110 is performed, such as by performing the method 400 of FIG. 4. However, in part 110′, the method 400 is performed in relation to the given concepts of each subtopic to determine how well the collected articles cover each subtopic. The coverage of the collected articles as to the topic itself may then be determined by averaging the coverages of the collected articles of the subtopics. For example, if there are three subtopics, then the method 400 is performed in relation to each subtopic, resulting in three coverages. These three coverages can then be averaged to result in the coverage of the collected articles as to the topic itself.

Finally, the uniqueness of the collected articles in comparison to one another is determined (112), as has been described, such as by performing the method 500 of FIG. 5. The method 600 of FIG. 6 thus permits a teacher to more directly guide students in researching a given school project, by providing desired subtopics in addition to a desired topic. The analytical measures are then determined by considering the subtopics selected by the teacher, in arriving at the analytic measures for the topic itself.

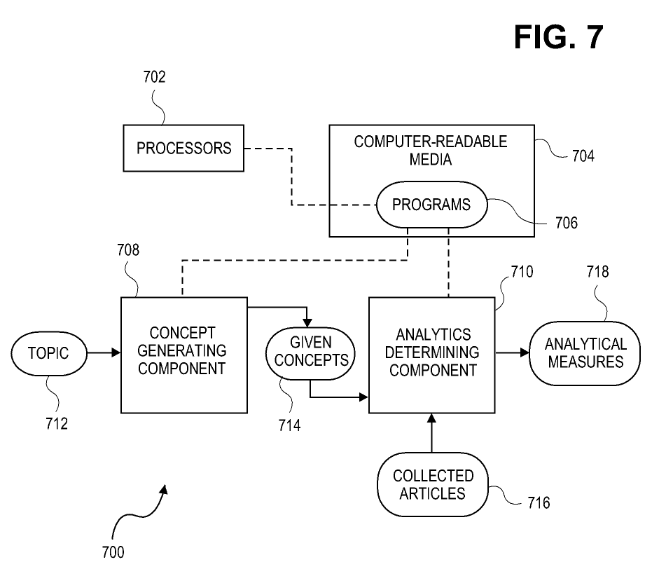

In conclusion, FIG. 7 shows a representative system 700, according to an embodiment of the present disclosure. The system 700 can be implemented over one or more computing devices, such as desktop computers, laptop computers, and other types of computing devices. Where there is more than one such computing device, the computing devices may be communicatively interconnected by one or more networks, such as a local-area network (LAN), a wide-area network (WAN), an intranet, an extranet, the Internet, as well as other types of networks.

The system 700 includes one or more processors 702 and one or more computer-readable media 704. The computer-readable media 704 stores one or more computer programs 706 that are executed by the processors 702, as indicated by a dotted line in FIG. 7. The computer-readable media 704 can include volatile and non-volatile semiconductor memory, magnetic media like hard disk drives, as well as other types of computer-readable media. The system 700 itself can include other hardware in addition to the processors 702 and the computer-readable media 704, such as network adapters, and so on.

The system 700 includes a concept generating component 708 and an analytics determining component 710. The components 708 and 710 are each implement by the computer programs 706 stored on the computer-readable media 704 and executed by the processors 702. The concept generating component 708 receives a teacher-selected topic 712, and responsively generates a number of given concepts 714, including their weights. For instance, the concept generating component 708 may perform parts 102, 102′, 104, and 104′ of FIGS. 1 and 6, as well as the method 200 of FIG. 2.

The analytics determining component 710 receives the given concepts 714 (and their weights) from the concept generating component 708. The analytics determining component 710 also receives student-collected articles 716. In response, the analytics determining component 710 generates one or more analytical measures 718 regarding the collected articles 716 in relation to the topic 712 selected by the teacher. These analytical measures 718 can include relevance, coverage, and uniqueness, as has been described. The analytical determining component 710 may thus perform parts 106, 108, 108′, 110, 110′, and 112 of FIGS. 1 and 6, as well as the methods 300, 400, and 500 of FIGS. 3, 4, and 5, respectively.

We claim:

1. A method comprising:
determining, by a computer program executed by a processor of a computing device, a plurality of analytical measures for a plurality of articles collected by a student in relation to a topic of an educational project, the analytical measures comprising one or more of:
a relevance of the articles collected by the student to the topic;
a coverage of how well the articles collected by the student cover the topic; and,
a uniqueness of the articles collected by the student in comparison to one another.

2. The method of claim 1, further comprising determining the relevance of the articles collected by the student to the topic of the educational project by:
for each article,
determining a plurality of concepts found in the article, each concept being a phrase of one or more words at least substantially particular to a knowledge domain specific to the article;
determining an appearance count for each concept in the article, equal to a number of times the concept appears in the article;
determining a weighted appearance count for each concept in the article, equal to the appearance count for the concept multiplied by a predetermined weight of the concept;
determining a relevance value for the article as an average of the weighted appearance counts for the concepts in the article; and,
determining the relevance of the articles by averaging the relevance values for the articles.

3. The method of claim 1, further comprising determining the coverage of how well the articles collected by the student cover the topic of the educational project by:
determining a plurality of concepts found in the articles, each concept being a phrase of one or more words at least substantially particular to a knowledge domain specific to the articles;
determining whether each of a plurality of predetermined concepts related to the topic appears within the concepts found in the articles; and,
determining the coverage of how well the articles collected by the student cover the topic of the educational project as a percentage of the predetermined concepts related to the topic that appear within the concepts found in the articles.

4. The method of claim 1, further comprising determining the uniqueness of the articles collected by the student in comparison to one another by:
for each article,
determining a plurality of concepts found in the article, each concept being a phrase of one or more words at least substantially particular to a knowledge domain specific to the article;
determining whether each of a plurality of predetermined concepts related to the topic appears within the concepts found in the article;
constructing a binary vector for the article, the binary vector having a plurality of binary values corresponding to whether the predetermined concepts appear within the concepts found in the article;
for each pair of one or more unique pairs of the articles,
determining a uniqueness value for the pair by applying a cosine similarity test to the binary vectors of the articles of the pair;
determining the uniqueness of the articles collected by the student in comparison to one another by averaging the uniqueness values for the pairs.

5. A computer-readable medium having a computer program stored thereon, wherein execution of the computer program by a processor results in performance of a method comprising:
determining a plurality of given concepts related to a topic of an educational project; and,
determining one or more of:
a relevance of a plurality of articles to the topic, based on the given concepts related to the topic, the articles collected by a student for the educational project;
a coverage of how well the articles collected by the student cover the topic, based on the given concepts related to the topic; and,
a uniqueness of the articles collected by the student in comparison to one another.

6. The computer-readable medium of claim 5, wherein determining the given concepts related to the topic of the educational project comprises:
locating a plurality of documents related to the topic, each document having a plurality of words;
for each document,
applying a general corpus tagging computer program to the document to tag a first subset of the words of the document that relate to a general knowledge domain;
extracting a second subset of the words of the document that were not tagged, the second subset of the words presumed to relate to a specific knowledge domain particular to the topic;
collecting a plurality of phrases from the second subset of the words of the document;
determining the given concepts related to the topic of the educational project as the phrases collected.

7. The computer-readable medium of claim 6, further comprising determining a weight of each given concept to the topic as a number of times the given concept appears within the documents, divided by a total number of times all the given concepts appear within the documents.

8. The computer-readable medium of claim 7, wherein determining the relevance of the articles collected by the student to the topic of the educational project comprises:
for each article,
determining a plurality of concepts found in the article, each concept being a phrase of one or more words at least substantially particular to a knowledge domain specific to the article;
determining an appearance count for each concept in the article, equal to a number of times the concept appears in the article;
determining a weighted appearance count for each concept in the article, equal to the appearance count for the concept multiplied by the weight of the concept;
determining a relevance value for the article as an average of the weighted appearance counts for the concepts in the article;
determining the relevance of the articles by averaging the relevance values for the articles.

9. The computer-readable medium of claim 6, wherein determining the coverage of how well the articles collected by the student cover the topic comprises:
determining a plurality of concepts found in the articles, each concept being a phrase of one or more words at least substantially particular to a knowledge domain specific to the articles;
determining whether each given concept appears within the concepts found in the articles; and,
determining the coverage of how well the articles collected by the student cover the topic of the educational project as a percentage of the given concepts that appear within the concepts found in the articles.

10. The computer-readable medium of claim 6, wherein determining the uniqueness of the articles collected by the student in comparison to one another comprises:
for each article,
determining a plurality of concepts found in the article, each concept being a phrase of one or more words at least substantially particular to a knowledge domain specific to the article;
determining whether each given concept appears within the concepts found in the article;
constructing a binary vector for the article, the binary vector having a plurality of binary values corresponding to whether the given concepts appear within the concepts found in the article;
for each pair of one or more unique pairs of the articles,
determining a uniqueness value for the pair by applying a cosine similarity test to the binary vectors of the articles of the pair;
determining the uniqueness of the articles collected by the student in comparison to one another by averaging the uniqueness values for the pairs.

11. The computer-readable medium of claim 5, wherein the given concepts are given topic concepts, and the method further comprises:
selecting one or more subtopics of the topic of the educational project from the given concepts related to the topic; and,
for each subtopic, determining a plurality of given subtopic concepts related to the subtopic,
wherein determining the relevance of the articles to the topic comprises determining the relevance of the articles to each subtopic of the topic,
and wherein determining the coverage of how well the articles cover the topic comprises determining the coverage of how well the articles cover each sub-topic of the topic.

12. The computer-readable medium of claim 5, wherein the relevance, the coverage, and the uniqueness are analytical measures that provide for one or more of:
how well the articles collected by the student satisfy the educational project;
a progress of the student in relation to the educational project, tracked on a periodic basis.

13. A system comprising:
one or more processors;
one or more computer-readable media to store one or more computer programs executable by the processors;
a concept generating component implemented by the computer programs to determine a plurality of given concepts related to a topic of an educational project; and,
an analytics determining component implemented by the computer programs to determine one or more of:
a relevance of a plurality of articles to the topic, based on the given concepts related to the topic, the articles collected by a student for the educational project;
a coverage of how well the articles collected by the student cover the topic, based on the given concepts related to the topic; and,
a uniqueness of the articles collected by the student in comparison to one another.

14. The system of claim 13, wherein the concept generating component is to:
for each of a plurality of documents related to the topic that have been located, where each document has a plurality of words,
apply a general corpus tagging computer program to the document to tag a first subset of the words of the document that relate to a general knowledge domain;
extract a second subset of the words of the document that were not tagged, the second subset of the words presumed to relate to a specific knowledge domain particular to the topic;
collect a plurality of phrases from the second subset of the words of the document;
determine the given concepts related to the topic of the educational project as the phrases collected;
determine a weight of each given concept to the topic as a number of times the given concept appears within the documents, divided by a total number of times all the given concepts appear within the documents.

15. The system of claim 14, wherein the analytics determining component is to:
determine a plurality of concepts found in each article, each concept having a phrase of one or more words at least substantially particular to a knowledge domain specific to the article;
determine the relevance of the articles to the topic by:
for each article,
determining an appearance count for each concept in the article, equal to a number of times the concept appears in the article;
determining a weighted appearance count for each concept in the article, equal to the appearance count for the concept multiplied by the weight of the concept;
determining a relevance value for the article as an average of the weighted appearance counts for the concepts in the article;
determining the relevance of the articles by averaging the relevance values for the articles;
determine the coverage of how well the articles cover the topic by:
determining whether each given concept appears within the concepts found in the articles;
determining the coverage of how well the articles collected by the student cover the topic of the educational project as a percentage of the given concepts that appear within the concepts found in the articles;
determine the uniqueness of the articles in comparison to one another by:
for each article,
determining whether each given concept appears within the concepts found in the article;
constructing a binary vector for the article, the binary vector having a plurality of binary values corresponding to whether the given concepts appear within the concepts found in the article;
for each pair of one or more unique pairs of the articles,
determining a uniqueness value for the pair by applying a cosine similarity test to the binary vectors of the articles of the pair;
determining the uniqueness of the articles collected by the student in comparison to one another by averaging the uniqueness values for the pairs.
